(19) United States
(12) Patent Application Publication
(10) Pub. No.: US 2025/0070991 A1
(43) Pub. Date: Feb. 27, 2025

(54) UNIFIED VIDEO CONFERENCE PLATFORM PROTOCOL

(71) Applicant: International Business Machines Corporation, Armonk, NY (US)

(72) Inventors: Manish Gupta, DELHI (IN); Ankit Gautam, Pune (IN); Deepak Gupta, Indirapuram (IN); Amit Deshpande, Pune (IN)

(73) Assignee: International Business Machines Corporation, Armonk, NY (US)

(21) Appl. No.: 18/236,679

(22) Filed: Aug. 22, 2023

(51) Int. Cl. H04L 12/18

(52) U.S. Cl. CPC H04L 12/1818; H04L 12/1822

(57) ABSTRACT

An embodiment establishes a unified conferencing protocol (UCP). The embodiment establishes a UCP mediator wherein the UCP mediator is configured to establish a connection between two or more video conferencing platforms. The embodiment receives, via the UCP mediator, a request to communicate with a first video conferencing platform from a second video conferencing platform. The embodiment approves, via the UCP mediator, the request to communicate with the first video conferencing platform from the second video conferencing platform. The embodiment establishes a connection between the first video conferencing platform and the second video conferencing platform.

### BACKGROUND

The present invention relates generally to video conference platform technology. More particularly, the present invention relates to a method, system, and computer program for a unified video conference platform protocol.

Video conference tools enable users from all over the world to connect with each other. Over the past few years, the number of users who utilize a video conference platform (“VCP”) has increased significantly. Accordingly, more users today communicate to each other via a VCP than ever before.

Further, due to technological development, remote work has also become more prevalent than ever before. Accordingly, most jobs that have historically been performed over a computer can now be remotely performed by a worker from the worker's home. The ability for workers to be able to work remotely effectively depends in part on the technologies employed by workers to communicate with each other. One type of technology that has become indispensable for the effective completion of remote work includes video conference technology, and more particularly, video conference platforms. VCPs enable workers to communicate, collaborate, share files with each other, and more.

A network protocol is an established set of rules that determine how data is transmitted between different devices in the same network. Accordingly, a network protocol enables connected devices to communicate with each other, regardless of any differences in internal processes, structure or design, including differences in software and/or hardware. Network protocols enable safe and easy communication between people all over the world, and thereby serve a critical role in modern digital communications.

### SUMMARY

The illustrative embodiments provide for a unified video conference platform protocol. An embodiment includes establishing a unified conferencing protocol (UCP). The embodiment also includes establishing a UCP mediator, wherein the UCP mediator is configured to establish a connection between two or more video conferencing platforms. The embodiment further includes receiving, via the UCP mediator, a request to communicate with a first video conferencing platform from a second video conferencing platform. The embodiment further includes approving, via the UCP mediator, the request to communicate with the first video conferencing platform from the second video conferencing platform. The embodiment further includes establishing a connection between the first video conferencing platform and the second video conferencing platform.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for software integration in accordance with an illustrative embodiment;

FIG. 3 depicts a block diagram of an example network environment including unified conferencing mediator in accordance with an illustrative embodiment;

FIG. 4 depicts a block diagram of an example unified conferencing mediator module in accordance with an illustrative embodiment;

FIG. 5 depicts a block diagram of an example process for initiating a communication session in accordance with an illustrative embodiment;

FIG. 6 depicts a diagram of an example one-to-one communication session in accordance with an illustrative embodiment;

FIG. 7 depicts a diagram of an example multi-party communication session in accordance with an illustrative embodiment;

FIG. 8 depicts a diagram of an example multi-party communication session enabled via a unified conferencing protocol in accordance with an illustrative embodiment;

FIG. 9A depicts a diagram of an example multi-party communication session between different video conferencing platforms in accordance with an illustrative embodiment;

FIG. 9B depicts a diagram of an example multi-party communication session between different video conferencing platforms mediated via a unified conferencing protocol in accordance with an illustrative embodiment;

FIG. 10 depicts a flowchart of an example process for establishing a connection to a conference system via a unified conferencing protocol in accordance with an illustrative embodiment; and

FIG. 11 depicts a flowchart of an example process for initiating, establishing, maintaining, and terminating a connection between a plurality of conference systems via a unified conferencing protocol in accordance with an illustrative embodiment.

### DETAILED DESCRIPTION

A video conferencing platform (“VCP”) enables users to communicate remotely between each other. In recent years, the number of remote meetings performed has increased, and is expected to continue to increase in coming years. Further, the percentage of work that is being performed remotely today is greater than ever before. Users may utilize a video conferencing platform to communicate between each other from every corner of the world. Today, video conferencing platforms and tools are at the backbone of effectively conducting business, across a wide range of different industries.

However, despite improvements in video conferencing platforms and tools, a number of issues relating to the use of video conferencing platforms and tools continue to exist. For example, one contemplated issue that exists is caused by the existence of many different available video conferencing platforms. Each video conferencing platform may be designed with a specific graphic user interface layout, and may require a new user to take time to learn the specific layout and how to operate the specific video conferencing platform. Accordingly, once a user has become accustomed to using a particular platform, it may be difficult for the user to familiarize themself with a different platform than the platform the user is already accustomed to using. The time and effort spent learning how to navigate and operate an unfamiliar platform could otherwise be spent productively during a meeting.

There are currently only limited solutions available for a user of a specific platform to communicate with a user of a different specific platform. Although some specific platforms may enable communication between each others' users, not all platforms are interoperable. These current limitations make it difficult for a user of a particular platform to communicate efficiently and effectively with another user utilizing a different platform. As a result, current efforts in this regard are inefficient and ineffective due to the current inability of users to communicate across different respective video conferencing platforms.

The present disclosure addresses the deficiencies described above by providing a process (as well as a system, method, machine-readable medium, etc.) that develops a multi-platform communication protocol as well as a mediator that interfaces between different video conferencing platforms. Disclosed embodiments combine a unified session initiation protocol with a mediator proxy server to establish, maintain, and/or terminate a communication between two or more different video conferencing platforms.

The illustrative embodiments provide for a unified video conferencing protocol (“UCP”) mediator and method of interfacing between two or more different video conference platforms. A “protocol” as described herein refers to a set of rules that defines how two or more computing devices (desktops, laptops, smartphones, routers, network switches, etc.) communicate with each other. It is contemplated herein that a particular video conferencing platform may utilize a particular protocol to enable users of the video conferencing platform to communicate with each other via the platform. The illustrative embodiments enable a user of a first video conferencing platform to communicate with another user of a second video conferencing platform, wherein the first video conferencing platform and the second video conferencing platform may be utilizing different respective protocols or different platform-specific variations of the same protocol.

As used throughout the present disclosure, the term “video conferencing platform” (or simply “VCP”) refers to a software application and/or service that enables real-time video and/or audio communication between multiple participants over a network, e.g., the Internet. A video conferencing platform enables participants from different remote locations to interact, collaborate, and share information with each other without being physically present in the same location. A user-participant interacts with a video conferencing platform via a graphical user interface (“GUI”), which may be accessed via web browser or on a dedicated application on a user device (e.g., computer, smartphone, tablet, etc.). Accordingly, a video conferencing platform may enable user device to collect and/or transmit audio and visual information via a camera, microphone, speakers, display screen, etc. The GUI typically includes a variety of controls, that enable a user to perform certain actions, including but not limited to, initiate a meeting, join a meeting, control audio settings, control video settings, share a screen, share a file, etc. A video conferencing platform may include various collaboration features, including but not limited to, text chat, file sharing, virtual backgrounds, polls, interactive whiteboards, etc. A video conferencing platform may also include a process for user authentication. Accordingly, to access a platform, a user may be required to sign in with an account. One object of user authentication includes prevention of unauthorized individuals from joining meetings. A video conferencing platform may also utilize a server infrastructure including a network of servers to handle the processing and distribution of audio and visual data. These servers may be utilized to facilitate the routing of data between participants, manage user connections, as well as handle various other aspects of a conferencing session. Further, the media streams (e.g., audio-visual data) are typically transmitted over the internet between participant devices and the server infrastructure that relay data from one participant to all other participants in a given session. A video conferencing platform may also utilize an encryption technique to protect data during transmission, thereby preventing unauthorized access to data contained in media streams.

As used throughout the present disclosure, the term “Session Initiation Protocol” (or simply “SIP” or “SIP protocol”) refers to a signaling protocol used for initiating, maintaining, and terminating communication sessions that include voice, video, and messaging applications. An SIP protocol defines the specific format of messages exchanged and the sequence of communications for cooperations of two or more participants. SIP is involved in the signaling operations of a media communication sessions and is primarily used to set up and terminate a voice or video call. SIP may be used to establish a two-party (unicast) session as well as a multiparty (multicast) session. Accordingly, by leveraging SIP, a video conferencing platform may provide seamless and reliable video conferencing experiences for users while enabling various features, including but not limited to, call management, media negotiation, and user presence awareness. When a user initiates a video conference session on a video conferencing platform or joins an existing session, the video conferencing platform uses SIP to establish a session between the participant's device and the platform's servers. Accordingly, SIP initiates the call setup process, exchanges signaling messages, negotiates media capabilities, agrees on codecs, and establishes communication parameters SIP is also responsible for maintaining the session's signaling path between participant devices and platform servers.

As used throughout the present disclosure, the term “Real-time Transport Protocol” (also known simply as “RTP”) refers to a network protocol for delivering audio, video, and other types of data over an IP network. In conjunction with a signaling protocol, e.g., SIP, RTP may be used to establish connections across a network. and enable users to communicate with each other over a VCP.

Illustrative embodiments include providing a protocol to enable communication between two or more different video conference tools. Illustrative embodiments further include establishing a unified conferencing protocol (“UCP”). Illustrative embodiments further include establishing a UCP mediator wherein the UCP mediator is configured to establish a connection between two or more video conferencing platforms. In some such embodiments, the UCP mediator is configured to translate between two or more platform-specific session initiation protocols. In an embodiment, the UCP mediator includes a proxy server configured as an intermediary between two or more video conferencing platforms.

Illustrative embodiments include a first protocol for establishing a connection between a first video conferencing software platform and a second video conferencing platform, wherein the first protocol may be configured to enable the first and second software application to exchange authorization information, identity information, and/or authentication information between each other. Illustrative embodiments further include a second protocol, wherein the second protocol is configured to enable the first video conferencing platform and the second video conference platform to continuously communicate between each other for a duration of a session.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved. two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

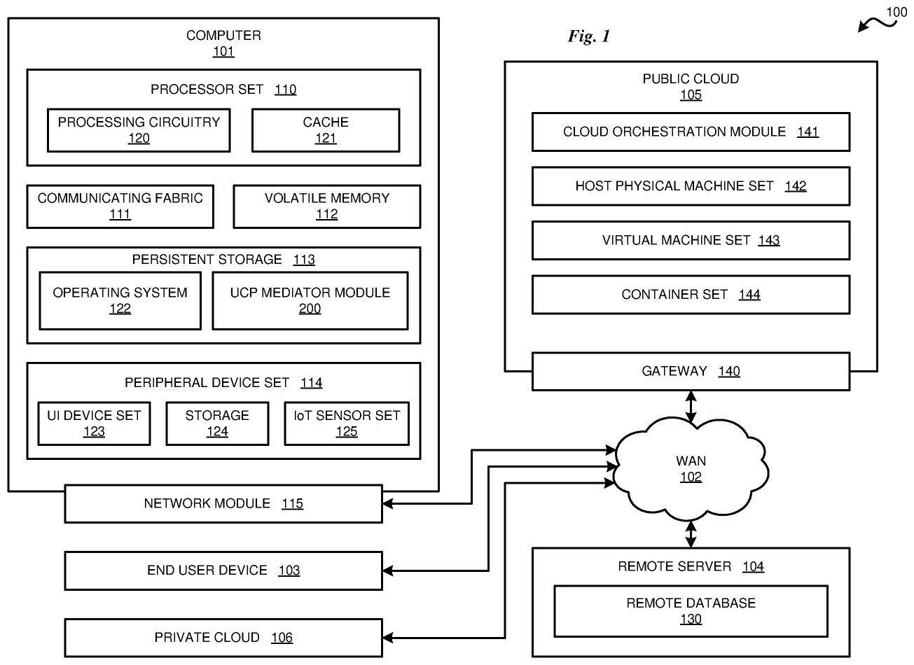

With reference to FIG. 1, this figure depicts a block diagram of a computing environment 100. Computing environment 100 contains an example of an environment for the execution of at least some of the computer code involved in performing the inventive methods, such as an UCP mediator module 200 that establishes and maintains a connection between two or more separate video conferencing platforms. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer. quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

In an embodiment, the process software including Unified Conference Protocol (UCP) is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

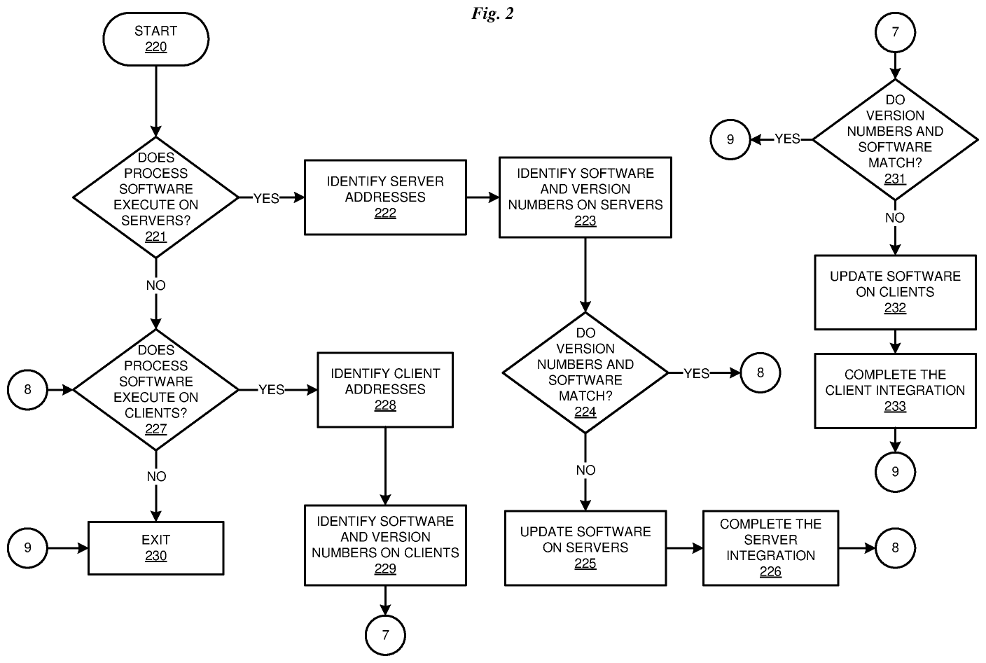

With reference to FIG. 2, this figure depicts a flowchart of an example process for software integration in accordance with an illustrative embodiment. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

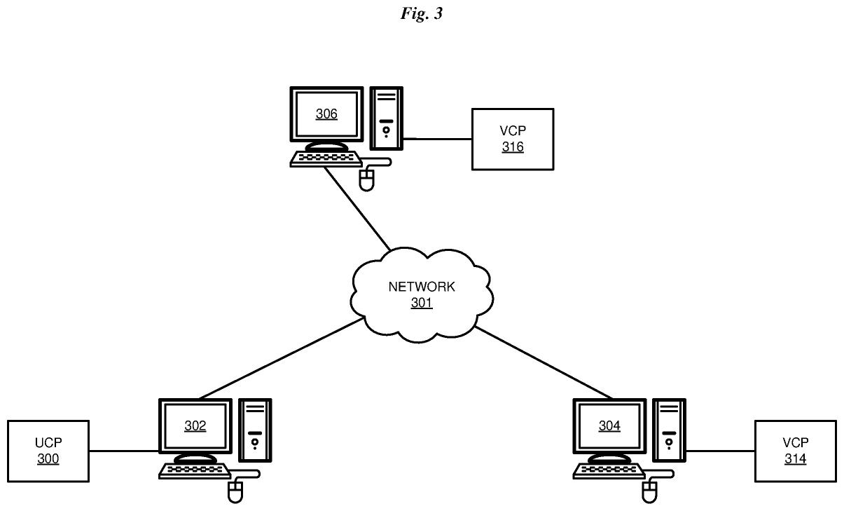

With reference to FIG. 3, this figure depicts a diagram of example network environment including unified conferencing mediator in accordance with an illustrative embodiment. In the illustrative embodiment, unified conference protocol module 300 includes UCP mediator module 200 of FIG. 1.

In the illustrated embodiment, a first endpoint device 304 deploying first video conferencing platform 314 is shown in communication with a second endpoint device 306 deploying a second video conferencing platform 316 via network 301. The first video conferencing platform 314 is enabled to communicate with the second video conferencing platform 316 via the unified conferencing protocol module 300. In an embodiment, the first video conferencing platform 314 enables communication between endpoint devices accessing the same first video conferencing platform 314, and the second video conferencing platform 316 enables communication between endpoint devices accessing the same second video conferencing platform 316. In an embodiment, first video conferencing platform 314 utilizes a first SIP protocol, and the second video conferencing platform 316 utilizes a second SIP protocol. Accordingly, the first SIP protocol may be different from the second SIP protocol, in which case, the first video conferencing platform 314 would ordinarily be unable to establish a connection with the second video conferencing platform 316.

In the illustrated embodiment, the UCP server 302 hosting the UCP module 300 acts as a proxy server between the first video conferencing platform 314 and the second video conferencing platform 316. Accordingly, the UCP server 302 may be configured to translate signals, messages, commands, requests, responses, etc., between the first video conferencing platform 314 and the second video conferencing platform 316. In an embodiment, the UCP module 300 includes an SIP mapping that defines a relationship between platform-specific SIP protocols corresponding to each video conferencing platform. In the illustrative embodiment, the UCP may extract SIP information/details from one or more source VCPs. SIP details from the source VCP may include, but are not limited to, SIP address, port, authentication credentials, as well as additional parameters. SIP details corresponding to the first VCP 314 may be converted to SIP details corresponding to the second VCP 316, or vice versa. In an embodiment, an SIP mapping is constructed from the SIP details corresponding to different respective source VCPs.

In the illustrated embodiment, the first video conferencing platform 314 provides services and service instances to the first endpoint device 304, and the second video conferencing platform 316 provides services and service instances to the second endpoint device 306. The first endpoint device 304 and the second endpoint device 306 may each communicate with the first video conferencing platform 314 and the second video conferencing platform 316, respectively, via an API gateway. In various embodiments, each video conferencing platform as well as the UCP module 300 may serve multiple users and multiple tenants. A tenant is a group of users (e.g., a company) who share common access with specific privileges to the software instance. Service infrastructure may ensure that tenant specific data is isolated from other tenants. Further, the service infrastructure may include a service registry. In some embodiments, the UCP module 300 is hosted on a virtual machine and the service registry looks up service instances for UCP module 300 in response to a service lookup request such as one from an API gateway in response to a service request from either the first endpoint device 304 or the second endpoint device 306.

Further, a backend administration system may allow users with administrative privileges to perform various administrative tasks associated with the UCP module 300. In some embodiments, a service registry maintains information about the status or health of each service instance including performance information associated each of the service instances. In some such embodiments, such information may include various types of performance characteristics of a given service instance (e.g., cache metrics, etc.) and records of updates.

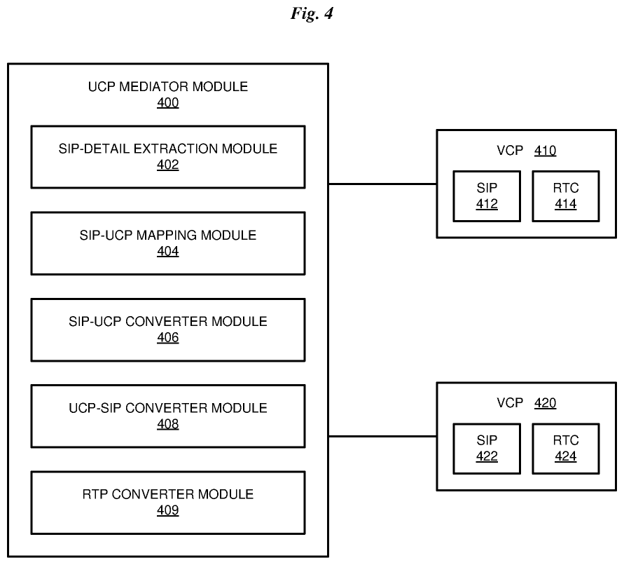

With reference to FIG. 4, this figure depicts a block diagram of an example UCP mediator module. In the illustrative embodiment, UCP mediator module 400 includes the UCP mediator module 200 of FIG. 1 and/or UCP mediator module 300 of FIG. 3.

In the illustrative embodiment, UCP mediator module 400 includes an SIP-detail extraction module 402, an SIP-UCP mapping module 404, an SIP-UCP converter module 406, a UCP-SIP converter module 408, and an RTP converter module 409. In alternative embodiments, the UCP mediator module 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrative embodiment, the UCP mediator module 400 is shown coupled to a first VCP 410 and a second VCP 320. As shown in FIG. 3, the first VCP 410 includes a first SIP whereas the second VCP 420 includes a second SIP 422. Suppose the first SIP 412 is different compared to the second SIP 422, in which case a user of the first VCP 410 would be ordinarily unable to communicate with a user of the second VCP 420. As shown in FIG. 4, since the first VCP 410 is coupled to the UCP mediator module 400 and the second VCP 420 is coupled to the UCP mediator module 400, a first user of the first VCP 410 may be able to communicate with a second user of the second VCP 420 via the UCP mediator module 400.

In the illustrative embodiment, SIP-detail extraction module 402 extracts details corresponding to an SIP protocol of a VCP. It is contemplated that a particular VCP will include particular SIP protocol details corresponding to instructions that enable two or more users to communicate to each other via the VCP. The SIP-detail extraction module 402 is configured to extract the details corresponding to particular instructions for initiating, maintaining, and/or terminating a communication session for a VCP. In an embodiment, SIP details are used to construct an SIP mapping between two or more VCPs, such as between the first VCP 410 and the second VCP 420.

In a particular embodiment, the UCP mediator module 400 includes a SIP-UCP mapping module 404 that defines a particular set of SIP details to a set of UCP protocol details. In such embodiment, UCP protocol details are constructed based on SIP protocol. In the same manner in which each SIP for each VCP may be unique, the UCP protocol may likewise be constructed from a unique SIP. The SIP-UCP mapping module 304 maps the SIP protocol details of a particular VCP according to the SIP of the UCP.

In a particular embodiment, UCP mediator module 400 includes an SIP-UCP converter module 406 that converts an SIP of a particular VCP to the UCP specific SIP. For example, when the first VCP 410 connects to the UCP mediator 400, the SIP details corresponding to the SIP 412 of the first VCP 310 may be converted via the SIP-UCP converter module 406 to an SIP corresponding to the UCP. In alternative embodiments, the UCP mediator module 400 translates between platform-specific SIPs without the use of a universal UCP based SIP protocol. In the illustrative embodiment, UCP-SIP converter module 408 converts a UCP encoded SIP to a platform specific SIP. In the illustrative embodiment, RTP converter module 409 converts media and/or media codec of the first VCP 410 to be suitable for the second VCP 420, and vice versa. Accordingly, it is contemplated that RTP 414 of VCP 410 may be incompatible with RTP 424 of VCP 420, in which case RTP converter module converts the RTP to a suitable format.

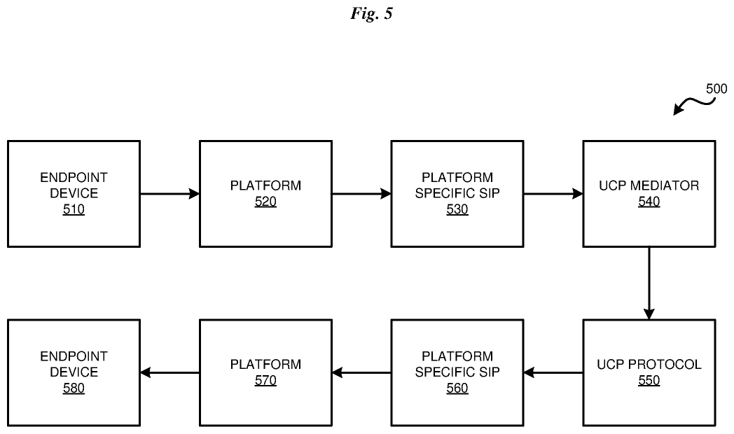

With reference to FIG. 5, this figure depicts a block diagram of an example process for interfacing between two different video conference platforms. In the illustrative embodiment, UCP mediator 540 includes UCP mediator module 400 of FIG. 4.

In the illustrative embodiment, a user connects to a first video conference platform 520 via a first endpoint user device 510. The first video conference platform 520 includes a corresponding first video conference platform SIP 530 that the first video conference platform 520 follows to enable communication between two or more users utilizing the first VCP 520. Ordinarily, the first platform specific SIP 530 would enable two users both using the same first VCP 520 to initiate a communication session between each other. However, the process 500 depicted in FIG. 5 depicts a scenario where two users each using different respective VCPs initiate a communication session with each other. Accordingly, since the first platform specific SIP 530 is different than the second platform specific SIP 560, a user of the first platform 520 would be unable to initiate a communication session with an other user of the second platform 570. In the illustrative embodiment, UCP mediator 540 converts the first platform specific SIP 530 to a second platform specific SIP 560. In the illustrative embodiment, the UCP mediator 540 includes UCP protocol 550 which is configured as a wrapper between the first platform-specific SIP 540 and the second platform-specific SIP 560 to enable interoperability between the first VCP 520 and the second VCP 570. As a nonlimiting example, a user of a first platform 520 may send a request to establish a connection to a user of a second platform 570. The UCP mediator 540 may convert the request to the appropriate platform-specific SIP request format so that the second platform 570 may receive the request to communicate to establish a connection with the first platform 520, and enable a user of a second endpoint device 580 to connect to the first platform 510 via the second platform 570.

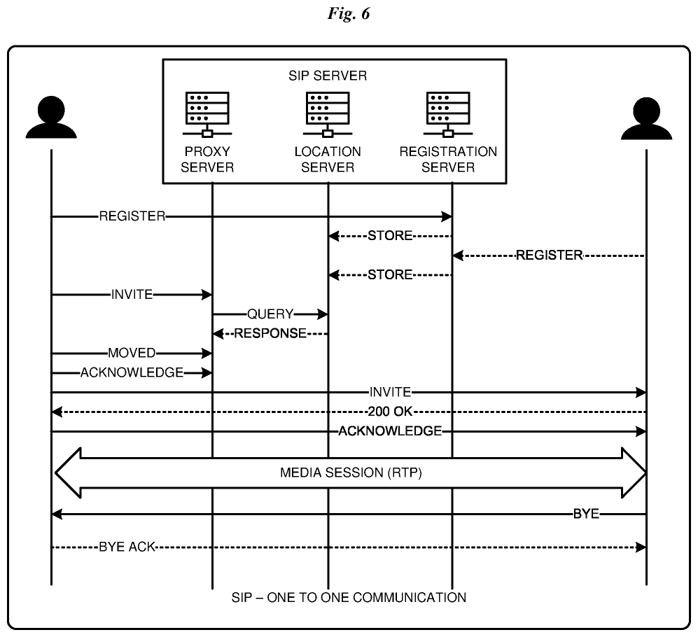

With reference to FIG. 6, this figure depicts a diagram of a one-to-one communication between two users. One-to-one video conferencing allows two individuals to communicate with each other in real-time through audio and video transmission over a network, e.g., the Internet. Each participant may utilize an endpoint device capable of handling video conferencing, such as a computer, laptop, tablet, or smartphone, etc. The endpoint device may include a camera, display, microphone, and speaker for capturing and transmitting audio and video data. The video and audio data are captured from the participants' devices using the participants' cameras and microphones. The received video and audio data may be rendered on the participants' screens and speakers simultaneously, allowing the participants to see and hear each other during the call. Further, Real-Time Transport Protocol (RTP) is typically used to transport audio and video data over the Internet by breaking the audio and video streams into packets and sending those packets over the established connection. Video data is typically encoded using a video codec, which compresses the video to reduce its size while maintaining an acceptable level of quality. An example codec may include, but is not limited to, H.264 and VP9. Further, audio data is typically encoded using an audio codec, such as for example, Opus or AAC, to compress the audio stream while preserving clarity. Further, an encryption technique may be utilized to ensure security Encryption protocols like Transport Layer Security (TLS) or Secure Real-time Transport Protocol (SRTP) are used to secure the data transmitted between the participants, ensuring that it cannot be intercepted or tampered with.

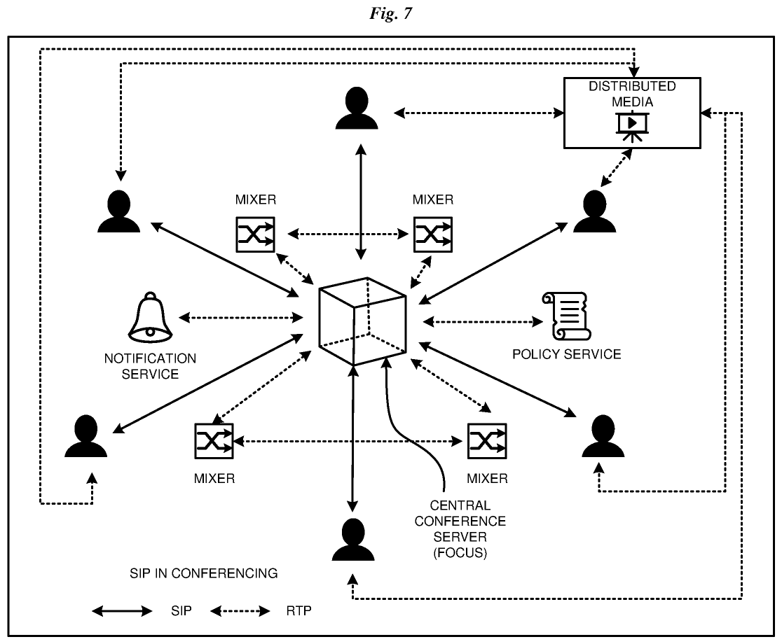

With reference to FIG. 7, this figure depicts a diagram of a multi-party communication via a central conference server, in accordance with an illustrative embodiment. In multipoint video calls, three or more locations may be connected together, where all participants can see and hear each other, as well as see any content being shared during a meeting session. Multipoint video calls are achieved by similar means as one-to-one communication, except notably multipoint video calls may utilize a central conference server. In this scenario, digital information streams of voice, video and content are processed by a central, independent software program called “virtual meeting room” and the digital processing hardware on which it resides, also referred to as a video bridge, or “bridge” or “multi-point control unit” (or simply “MCU”). The MCU may enable the performance of various tasks, including but not limited to, creating, controlling and facilitating multiple simultaneous live video conferencing meetings, combining the individual participant's video and voice traffic (the program re-sends a collective data stream back to meeting participants in the form of real-time audio and video imagery), enabling those participants to view the video bridge at the highest speed and the best possible quality that their individual system can support, understanding and translating between several different protocols (i.e. H.264 for communication over IP, and H.263 for ISDN), and more.

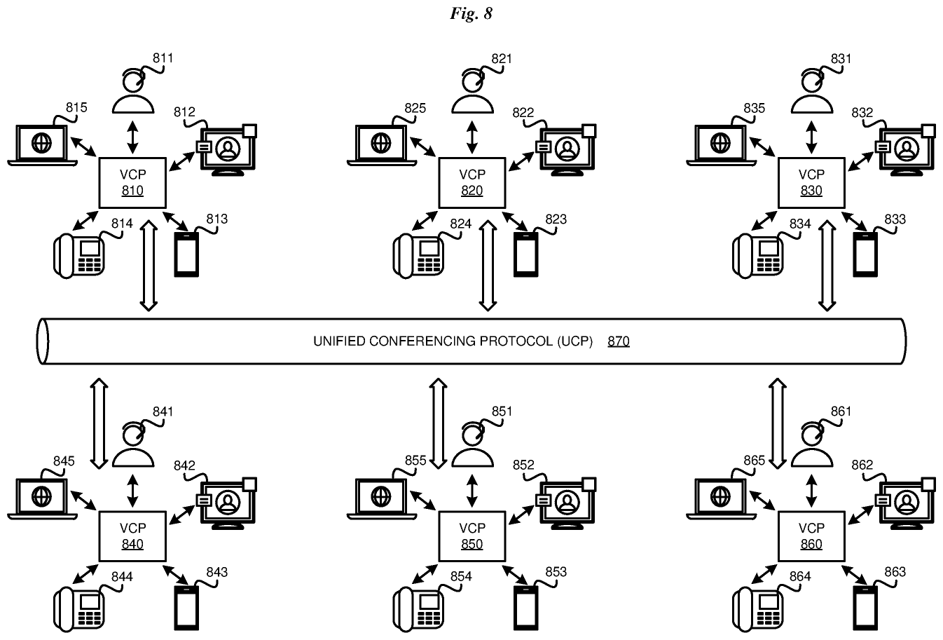

With reference to FIG. 8, this figure depicts a diagram of a plurality of VCPs in communication with each other via a unified conferencing protocol. In the illustrative embodiment, unified conferencing protocol (UCP) 870 includes UCP mediator module 200 of FIG. 1, UCP module 300 of FIG. 3, and/or UCP mediator module 400 of FIG. 4.

As shown in FIG. 8, a plurality of different video conferencing platforms are connected to the UCP 870. The plurality of different video conferencing platforms includes a first VCP 810, a second VCP 820, a third VCP 830, a fourth VCP 840, a fifth VCP 850, and a sixth VCP 860. Further, each video conferencing platform of the plurality of different video conferencing platforms is shown connected to a plurality of different possible endpoint devices that may be utilized to enable users to communicate to each other. As shown in FIG. 8, the first VCP 810 may be accessed via a first headset device 811, a first desktop application 812, a first smartphone application 813, a first telephone 814, and/or or a first web application 815. The second VCP 820 may be accessed via a second headset device 821, a second desktop application 822, a second smartphone application 823, a second telephone 824, and/or or a second web application 825. The third VCP 830 may be accessed via a third headset device 831, a third desktop application 832, a third smartphone application 833, a third telephone 834, and/or or a third web application 835. The fourth VCP 840 may be accessed via a fourth headset device 841, a fourth desktop application 842, a fourth smartphone application 843, a fourth telephone 844, and/or or a fourth web application 845. The fifth VCP 850 may be accessed via a fifth headset device 851, a fifth desktop application 852, a fifth smartphone application 853, a fifth telephone 854, and/or or a fifth web application 855. The sixth VCP 860 may be accessed via a sixth headset device 861, a sixth desktop application 862, a sixth smartphone application 863, a sixth telephone 864, and/or or a sixth web application 865. Although six VCPs are shown in FIG. 8, it is contemplated herein that any number of VCPs may be connected to each other via the UCP 870.

In the illustrative embodiment, the UCP 870 is implemented via a UCP mediator. In an embodiment, the UCP mediator includes two mediators. A first mediator may be configured to code and decode request and responses between UCP and VCP specific format. The second mediator may be configured to secure communication between a particular VCP central server and clients of another VCP. For example, suppose a meeting is hosted by a central server of first VCP 810, and a client of the second VCP 820 wishes to join the meeting, then the second mediator may secure communication between the first VCP 810 central server and clients of the second VCP 820.

In the illustrative embodiment, the UCP 870 classifies communication in two parts, including via one or more web socket connections and one or more rest API calls. In an embodiment, the UCP utilizes one or more web socket connections for continuous streaming of audio data and/or video data. The one or more web socket connections may likewise be utilized for publishing any events due to changes caused by invocation of rest calls by multiple participants. Further, the one or more web socket connections may be utilized for broadcasting initial and incremental changes to the connection. Further, in an embodiment, the UCP utilizes rest API calls for issuing commands, including but not limited to, mute/unmute, raise hand, take over control of presentation, share screen, etc.

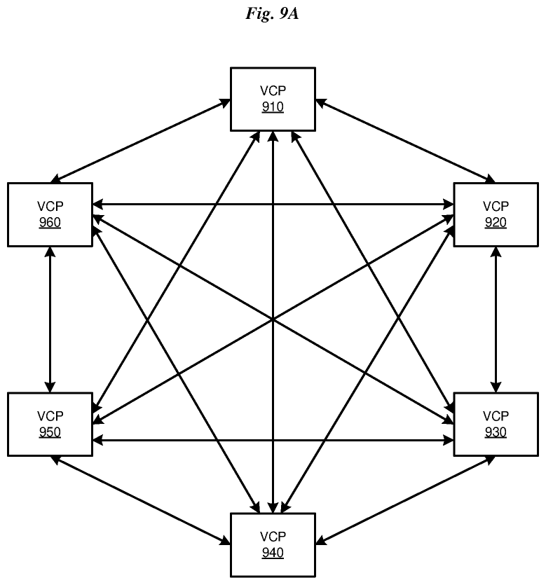

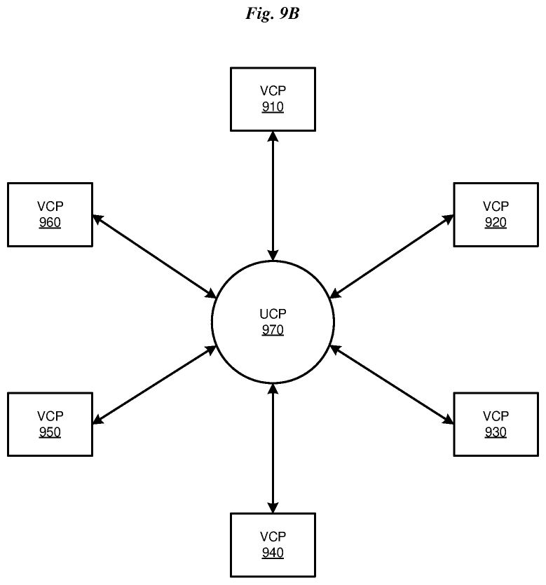

With reference to FIG. 9A, this figure depicts a plurality of VCPs in communication with each other without utilizing a unified conferencing protocol. Accordingly, the plurality of VCPs as shown includes a first VCP 910, a second VCP 920, a third VCP 930, a fourth VCP 940, a fifth VCP 950, and a sixth VCP 960. As depicted in FIG. 9, each VCP of the plurality of VCPs is shown connected to each other VCP. For example, VCP 910 is shown connected to VCP 920, VCP 930, VCP 940, VCP 950, and VCP 960. It is contemplated herein that some specific individual VCPs may be interoperable with some other specific VCPs. However, as shown by FIG. 9A, the complexity of data transfer between the VCPs increases as the number of VCPs increases.

With reference to FIG. 9B. this figure depicts a plurality of VCPs in communication with each other via a UCP mediator. In contrast to FIG. 9A, FIG. 9B includes a UCP mediator 970 that may be configured as a proxy server between each VCP of the plurality of VCPs. It is contemplated that the inclusion of the UCP 970 reduces the latency between data transfer between VCPs. Further, the number of VCPs does not increase the complexity of data transfer between VCPs when each VCP is interfacing between each other using the UCP 970. It is contemplated herein that the UCP 970 provides a significant improvement to the functioning of the underlying computer technology utilized to accomplish audio and/or video data transfer, by reducing the computational complexity associated with such data transfer, and reducing the latency associated with audio and/or video data transfer.

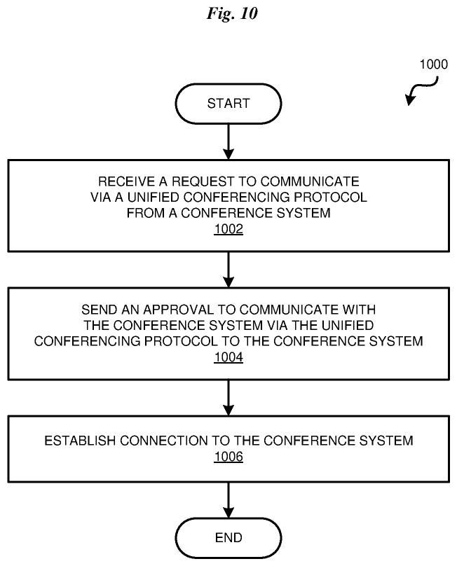

With reference to FIG. 10, this figure depicts a flowchart of an example process for initiating communication between two VCPs via a UCP mediator. In an embodiment, UCP mediator module 200 of FIG. 1 is configured to carry out process 1000.

At step 1002, the process receives a request to communicate via a unified conferencing protocol (“UCP”) mediator from a conference system. At step 1004, the process sends an approval to communicate with the conference system via the unified conferencing protocol to the conference system. At step 1006, the process establishes a connection to the conference system. In an embodiment, the process further includes providing a URL enabling a user from any location to establish a connection the conference system to join an existing communication session. In an embodiment, the process further includes providing a token-based authentication system to authenticate the identity of a user attempting to join a session hosted via the conference system.

In an embodiment, the process 1000 establishes a connection between a first VCP and a second VCP via the UCP mediator. In some such embodiments, the UCP mediator may include a proxy server configured to interface between the first VCP and the second VCP. Further, in some such embodiments, the UCP mediator may include a protocol wrapper to enable interoperability between the first VCP and the second VCP. In an embodiment, the process 1000 receives, via the UCP mediator, a request to communicate with the first VCP from the second VCP. The process approves, via the UCP mediator, the request to communicate with the first VCP from the second VCP. Further, the process establishes a connection between the first video conferencing platform and the second video conferencing platform. As a nonlimiting example example, the first VCP may include a first platform specific INVITE command, which might not be compatible with the second VCP. In such scenario, the UCP mediator may translate the first platform specific INVITE command to second platform specific INVITE command via an SIP mapping, so that the second VCP may be able to receive the INVITE command sent by the first VCP. Accordingly, the process may translate the request to communicate sent by the second VCP via the UCP mediator thereby enabling the first VCP to receive and/or respond to the request to communicate sent by the second VCP.

In an embodiment, the process further includes handling one or more discrepancies between the first VCP and the second VCP. For example, if the first VCP supports a specific feature that the second VCP does not support, the UCP mediator may inform a user and/or negotiate an alternative feature supported by both the first VCP and the second VCP. Further, in an embodiment, the process maintains the connection between the first VCP and the second VCP. Further, in an embodiment, the process transcodes media sent by the first VCP and the second VCP to a media codec that is suitable for either the first VCP or the second VCP. Further, in an embodiment, the process terminates the connection between the first VCP and the second VCP upon receiving a request to terminate the communication from either the first VCP or the second VCP.

Although process 1000 is described with reference to a first VCP and a second VCP, it is contemplated herein that the process may likewise be utilized to establish a connection between any number of VCPs. For example, it may be the case that a connection has been established between a first VCP and a second VCP, in which case the process may establish a connection between the first VCP and the second VCP and a third VCP. Also, it may be the case that a connection has been established between a first VCP, a second VCP, and a third VCP, in which case the process may establish a connection between the first VCP, the second VCP, the third VCP, and a fourth VCP. Accordingly, the process may establish a connection between any number of VCPs to each other. Further, although the process 1000 is described with reference to translating between platform specific session initiation protocol configurations, it is contemplated herein that the process may likewise translate between any type of platform specific protocol configurations, including for example, RTP, and any other protocols related to video-conferencing technology.

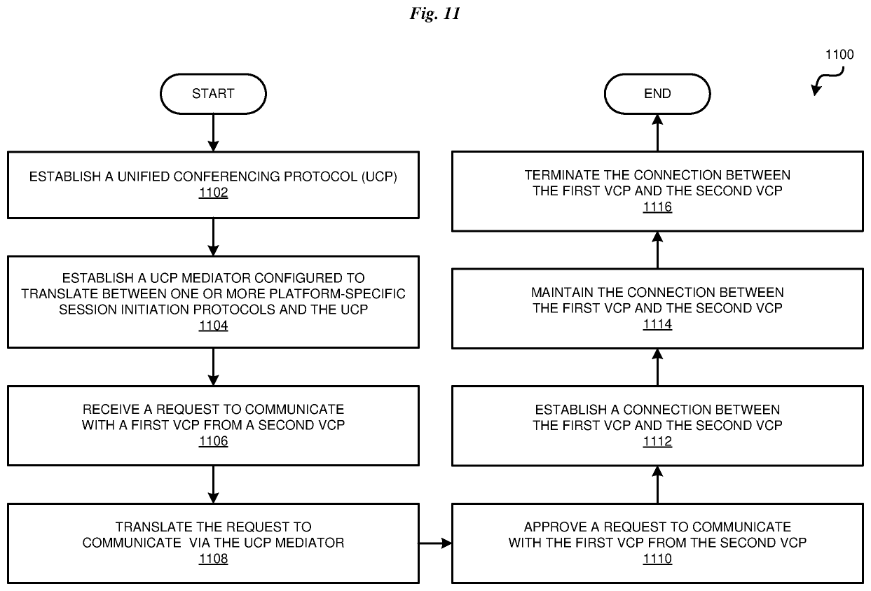

With reference to FIG. 11, this figure depicts a flowchart of an example process for initiating, establishing, maintaining, and terminating a connection between a plurality of conference systems via a unified conferencing protocol in accordance with an illustrative embodiment. In an embodiment, UCP mediator module 200 of FIG. 1 is configured to carry out process 1100.

At step 1102, the process establishes a unified conferencing protocol (“UCP”). It is contemplated that each video conferencing platform (“VCP”) may comprise a platform-specific session initiation protocol (“SIP”) that makes it ordinarily impossible for two different VCPs comprising two different respective SIPs to communicate data between each other. Accordingly, establishing the UCP may include creating a universal SIP protocol that is not exclusive to any specific VCP. In an embodiment, the UCP may include a set of universal SIP commands, including requests and responses.

At step 1104, the process establishes a UCP mediator. In an embodiment, the UCP mediator may be configured to translate between one or more platform-specific SIPs and the UCP. In an embodiment, the UCP mediator includes a UCP-SIP mapping, wherein the UCP-SIP mapping defines one or more relationships between the UCP and one or more platform specific SIPs. Suppose a first VCP may include a first platform specific SIP, and a second VCP may include a second platform specific SIP. In such scenario, the UCP-SIP mapping defines the relationship between a first platform specific SIP command and a UCP based SIP command, as well as the relationship between a second platform specific SIP command and a UCP based SIP command. To continue on the previous example, the first VCP may include a first platform specific INVITE command, which might not be compatible with the second VCP. In such scenario, the UCP mediator may translate the first platform specific INVITE command to a second platform specific INVITE command via the UCP-SIP mapping, so that the second VCP may be able to receive the INVITE command sent by the first VCP.

At step 1106, the process receives a request to communicate with a first VCP from a second VCP. As described above, it is contemplated herein that the request to communicate sent from the second VCP may be ordinarily incompatible with the first VCP. At step 1108, the process translates the request to communicate sent by the second VCP via the UCP mediator, thereby enabling the first VCP to receive and/or respond to the request to communicate sent by the second VCP.

At step 1110, the process approves the request to communicate with the first VCP sent from the second VCP. At step 1112, the process establishes a connection between the first VCP and the second VCP. In an embodiment, the process further includes handling one or more discrepancies between the first VCP and the second VCP. For example, if the first VCP supports a specific feature that the second VCP does not support, the UCP mediator may inform a user and/or negotiate an alternative feature supported by both the first VCP and the second VCP.

At step 1114, the process maintains the connection between the first VCP and the second VCP. In an embodiment, the process At step 1116, the process further transcodes media sent by the first VCP and the second VCP to a media codec that is suitable for either the first VCP or the second VCP. In an embodiment, the process terminates the connection between the first VCP and the second VCP upon receiving a request to terminate the communication from either the first VCP or the second VCP. Although the process is described with reference to a first VCP and a second VCP, it is contemplated herein that the process may likewise be utilized to establish a connection between any number of VCPs. For example, it may be the case that a connection has been established between a first VCP and a second VCP, in which case the process may establish a connection between the first VCP and the second VCP and a third VCP. Also, it may be the case that a connection has been established between a first VCP, a second VCP, and a third VCP, in which case the process may establish a connection between the first VCP, the second VCP, the third VCP, and a fourth VCP. Accordingly, the process may establish a connection between any number of VCPs to each other.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method. system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing a unified conferencing protocol (UCP) mediator wherein the UCP mediator is configured to establish a connection between two or more video conferencing platforms;
receiving, via the UCP mediator, a request to communicate with a first video conferencing platform from a second video conferencing platform;
approving, via the UCP mediator, the request to communicate with the first video conferencing platform from the second video conferencing platform; and
establishing a connection between the first video conferencing platform and the second video conferencing platform.

2. The computer-implemented method of claim 1, further comprising translating the request to communicate with the first video conferencing platform from the second video conferencing platform from a second platform-specific invitation request to a first platform-specific invitation request.

3. The computer-implemented method of claim 2, wherein the first platform-specific invitation request is encoded according to a first session initiation protocol corresponding to the first video conferencing platform and the second platform-specific invitation request is encoded according to a second session initiation protocol corresponding to the second video conferencing platform.

4. The computer-implemented method of claim 3, further comprising establishing a session initiation protocol mapping, wherein the session initiation protocol mapping defines a relationship between the first session initiation protocol and the second session initiation protocol, and wherein translating the request to communicate with the first video conferencing platform from the second video conferencing platform is accomplished via the session initiation protocol mapping.

5. The computer-implemented method of claim 1, further comprising maintaining the connection between the first video conferencing platform and the second video conferencing platform.

6. The computer-implemented method of claim 1, further comprising terminating the connection between the first video conferencing platform and the second video conferencing platform.

7. The computer-implemented method of claim 1, further comprising handling one or more discrepancies between the first video conferencing platform and the second video conferencing platform.

8. The computer-implemented method of claim 1, further comprising transcoding media between the first video conferencing platform and the second video conferencing platform.

9. The computer-implemented method of claim 1, further comprising establishing a connection between the first video conferencing platform, the second video conferencing platform, and a third video conferencing platform.

10. The computer-implemented method of claim 9, further comprising establishing a connection between the first video conferencing platform, the second video conferencing platform, the third video conferencing platform, and a fourth video conferencing platform.

11. A computer program product for interfacing between different video conference platforms comprising one or more computer readable storage media, and program instructions collectively stored on the one or more computer readable storage media, the program instructions executable by a processor to cause the processor to perform operations comprising:
establishing a unified conferencing protocol (UCP) mediator, wherein the UCP mediator is configured to establish a connection between two or more video conferencing platforms;
receiving, via the UCP mediator, a request to communicate with a first video conferencing platform from a second video conferencing platform;
approving, via the UCP mediator, the request to communicate with the first video conferencing platform from the second video conferencing platform; and
establishing a connection between the first video conferencing platform and the second video conferencing platform.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, further comprising translating the request to communicate with the first video conferencing platform from the second video conferencing platform from a second platform-specific invitation request to a first platform-specific invitation request.

15. The computer program product of claim 14, wherein the first platform-specific invitation request is encoded according to a first session initiation protocol corresponding to the first video conferencing platform and the second platform-specific invitation request is encoded according to a second session initiation protocol corresponding to the second video conferencing platform.

16. The computer program product of claim 15, further comprising establishing a session initiation protocol mapping, wherein the session initiation protocol mapping defines a relationship between the first session initiation protocol and the second session initiation protocol, and wherein translating the request to communicate with the first video conferencing platform from the second video conferencing platform is accomplished via the session initiation protocol mapping.

17. The computer program product of claim 11, further comprising handling one or more discrepancies between the first video conferencing platform and the second video conferencing platform.

18. A computer system for establishing and maintaining a connection between two or more video conferencing services, the computer system comprising:
a unified conferencing protocol (UCP) module, wherein the UCP module comprises:
an initialization module, wherein the initialization module exchanges authorization, identity, and authentication information between two or more different video conferencing services; and
a communication module, wherein the communication module maintains media exchange between the two or more different video conferencing services; and
a web-server, wherein the web-server comprises:
a processor;
one or more computer readable storage media, wherein the one or more computer readable storage media stores the UCP module; and
program instructions collectively stored on the one or more computer readable storage media, the program instructions executable by the processor to cause the processor to perform operations comprising:
receiving, via the UCP module, a request to communicate with a first video conferencing service from a second video conferencing service;
approving, via the UCP module, the request to communicate with the first video conferencing service from the second video conferencing service;
establishing, via the UCP module, a connection between the first video conferencing service and the second video conferencing service; and
maintaining, via the UCP module, the connection between the first video conferencing service and the second video conferencing service.

19. The computer system of claim 18, further comprising handling one or more discrepancies between the first video conferencing service and the second video conferencing service.

20. The computer system of claim 18, further comprising transcoding media between the first video conferencing service and the second video conferencing service.
